(19) United States
(12) Patent Application Publication
(10) Pub. No.: US 2006/0085348 A1
(43) Pub. Date: Apr. 20, 2006

(54) Method and system for managing the use of electronic works

(75) Inventors: Anthony A. J. Alda, Vancouver (CA); Brent R. Bysouth, Vancouver (CA); Thomas J. Routt, Edmonds, WA (US); Stephane Vaudandaine, Vancouver (CA); Andrew Andreev, Vancouver (CA); Igor Kakhaia, Vancouver (CA); Vincent Siu, Vancouver (CA); D. Brett Rudd, Vancouver (CA); Shazron Abdullah, Vancouver (CA); L. Clayton D. Bell, Vancouver (CA)

Correspondence Address: EDWARDS & ANGELL, LLP, P.O. BOX 55874, BOSTON, MA, 02205, US

(73) Assignee: NS8 Corporation, Vancouver (CA)

(21) Appl. No.: 11/183,416

(22) Filed: Jul. 18, 2005

Related U.S. Application Data
(60) Provisional application No. 60/588,556, filed on Jul. 16, 2004.

(51) Int. Cl. G06Q 99/00

(52) U.S. Cl. 705/52

(57) ABSTRACT

A system for managing, distributing and using of electronic content. The system includes an encoding/encryption appliance for receiving content and creating protected content, a distribution appliance for defining one or more grants, a consumption appliance for exercising the one or more grants to transform the protected content into exercisable content, and a licensing appliance to coordinate passage of the electronic content from the encoding/encryption appliance to the distribution appliance to the consumption appliance in a distributed computing environment.

### CROSS-REFERENCE TO RELATED APPLICATION

This application claims priority to U.S. Provisional Patent Application No. 60/588,556, filed Jul. 16, 2004, which is incorporated herein by reference.

### BACKGROUND OF THE INVENTION

1. Field of the Invention

The subject disclosure relates to methods and systems for managing the authorized usage of digital works, where a digital work is any digital representation of content, including but not limited to, audio, video, graphical, textual, mixed-object, computer programs, or network application programs.

2. Background of the Related Art

Since the beginning of man's ability to fix expressive works such as literature, music and art, man has sought the ability to protect and profit from his creations. Over the centuries various advances in copying technology have posed new challenges to maintaining control over one's work. In response, governments have adapted their laws in efforts to be provide a fair return for the copyright owners.

In the modern information age, the ability to distribute electronic copies of digital works is at an unprecedented high level as compared with any other time in history. The pervasive availability of digital works without attribution back to the creators threatens to chill creativity. In view of the need to address distribution of digital content, many systems for enforcing copyright or other such protection have been proposed. However, such systems make properly accessing electronic content so tedious and expensive that effective and efficient distribution does not occur.

For example, the disclosure of U.S. Pat. No. 6,763,464 to Wang et al. (the '464 patent), which is incorporated herein by reference, is directed to documents rights management that enables document protections without the need for additional software and hardware. The '464 patent creates self-protecting documents (SPD) that combine an encrypted document with a set of permissions and an executable code segment for extracting the encrypted document. Simultaneously with encryption, the digital content is also polarized with a key. As a result, clear content (e.g., the unencrypted document) is not available to the user at the rendering appliance. In other words, the invention of the '464 patent is a scheme to prevent a user from obtaining a useful form of the document during rendering.

In the '464 patent, a publisher 110 creates the original content 112 and passes it to a distributor 114. The distributor 114 passes the content 112 to users 118. A payment 120 is passed from the user 118 to the distributor 114 by way of a clearinghouse 122. For each use, an accounting message 128 is sent to an audit server 130 to ensure that each usage matches with what the distributor 114 sent.

The '464 patent also discusses and contrasts its invention with the art in the specification. In the typical system, the distribution is noted as similar to that described above. However, the intermediate step of polarizing is absent. The user 118 simply receives the original content 112 and is able to use his private key to decrypt the modified content 116 and view the original content.

The additional protection of the SPD is provided by a protecting shell 320 in the '464 patent. The protecting shell is created in an intermediate “polarization” step to secure the digital content during rendering. At the distributor 114, a polarization engine 412 scrambles the digital content in such a way that the rendering application 424 at the user 118 can still process the polarized contents albeit not into a usable form. The resulting polarized data 426 is passed to a depolarization engine 428 at the user 118 just before presentation to restore the original form of the content. Unfortunately for the user, the depolarization engine functions so that a clear form of the content does not become available to the user 118.

For another example, U.S. Pat. No. 6,236,971 to Stefik et al. (the '971 patent), which is incorporated herein by reference, is directed to a system for controlling the distribution of digital works using digital tickets. A key feature of the invention is the attachment of the usage rights to the digital work. Since the usage rights are attached to the digital work, control can be exercised over all uses of copies. In order to exercise a usage right, the requesting repository must have an appropriate digital ticket. For example, a digital ticket to make 5 copies of a work can be purchased. The digital tickets are “punched” or decremented to indicate a copy of the digital work has been made. In some embodiments, the digital ticket must be presented to a special ticket agent in order to be punched.

The digital works are stored in a first repository. A user or second repository requests access to a digital work. The first repository determines if the request may be granted based upon the usage rights associated with the digital work if the appropriate digital ticket is presented. In another embodiment, a special ticket agent punches the digital ticket. By punching, the '971 patent refers to making an indication on the digital ticket that the usage right has been exercised. By permanently attaching the usage rights to the digital work, the '971 patent attempts to maintain the digital work in trusted repositories that will always enforce the attached usage rights. Thus, control over the digital work is maintained after a user gains access to the server but not after a user gains access to the digital work.

### SUMMARY

In view of the above, a need exists for a system that allows users access to digital works yet controls distribution of the digital works without unduly burdensome technology.

The present disclosure is directed to a method and system for managing the authorized usage of digital works. A “digital work” is any digital representation of content, including but not limited to audio, video, graphical, textual, mixed-object, computer programs, or network application programs. Digital work management can include the distribution and consumption of the digital work, as well as any other use. Consumption of digital work, for example, is the rendering of the digital work to its intended audience. In a particular example, distribution of the digital work is the transportation of the digital work to a location where the content can be consumed by its intended audience.

One embodiment of the subject technology is directed to a server for facilitating distributing digital works, wherein the server communicates with servers and clients via a distributed computing network. The server includes a memory storing an instruction set and data related to a plurality of consumption appliances, a plurality of encoding/encryption appliances and distribution edges associated with digital works. The server also has a processor for running the instruction set, the processor being in communication with the memory and the distributed computing network, wherein the processor is operative to receive protected content from an encryption/encoding appliance, add rules to the protected content that govern consumption and distribution of the protected content, and send the protected content with the rules to a consumption appliance such that the consumption appliance can render the protected content into an exercisable form if such usage is permitted.

Another embodiment of the subject technology is directed to a computer-readable medium whose contents cause a server to perform a method for facilitating distribution and consumption of content in a distributed computing environment. The distributed computing environment has a plurality of encoding appliances, consumption appliances and distribution appliances. The server has a digital signal processor and a program with functions for invocation by performing the steps of receiving an encryption table associated with a work from an encoding appliance, creating a first identifier for the work, the first identifier being associated with the encryption table and sending the first identifier to the encoding appliance. The program also contains function for performing the steps of receiving a ruleset table associated with the work from a distribution appliance, creating a second identifier for the work, the second identifier being associated with the ruleset table, and sending the second identifier to the distribution appliance. The program further contains function for performing the steps of receiving a grant exercise table associated with the work from a consumption appliance, creating a decoding table for the work based upon the grant exercise table, the ruleset table and the encryption table, and sending the decoding table to the consumption appliance.

It is an object of the subject technology that subsequent rules added by distribution appliance should not only be cumulative but be intelligently overridden by previously applied rules.

It is an object of the subject technology to provide an n-generational distribution model because multiple distribution paths can be followed for any given content.

It should be appreciated that the present invention can be implemented and utilized in numerous ways, including without limitation to analog works, as a process, an apparatus, a system, a device, a method for applications now known and later developed or a computer readable medium. These and other unique features of the method and system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the drawings as follows.

FIG. 1 is an overview of an environment in which an embodiment of the present technology may be used.

FIG. 2 is a distribution graph of protected content in accordance with the present technology.

FIG. 3a presents a minimal Distribution Ruleset required to control permutations of a Distribution Graph in accordance with the present technology.

FIG. 3b elaborates on the Distribution Ruleset introduced in FIG. 3a.

FIG. 4 illustrates an overview of presentation of unprotected content as an input to the Encoding/Encryption Appliance in accordance with the present technology.

FIG. 5 illustrates an overview of passage of protected content as an input to the Distribution Appliance in accordance with the present technology.

FIG. 6 illustrates an overview of passage of protected content to the Consumption Appliance in accordance with the present technology.

### DETAILED DESCRIPTION OF PREFERRED EMBODIMENTS

The present invention overcomes many of the prior art problems associated with distribution of electronic content or works. The advantages, and other features of the system disclosed herein, will become more readily apparent to those having ordinary skill in the art from the following detailed description of certain preferred embodiments taken in conjunction with the drawings which set forth representative embodiments of the present invention.

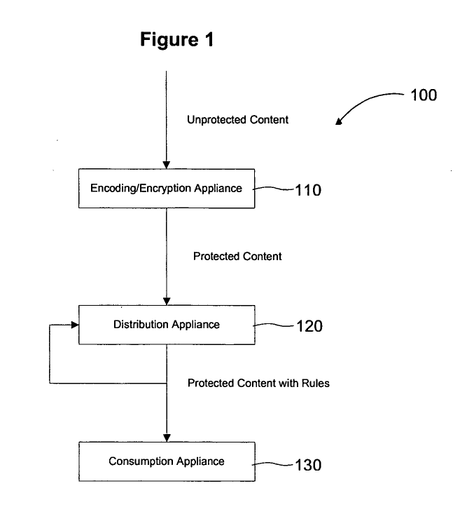

Referring to FIG. 1, a system facilitating transformation of unprotected content into protected content, then to protected content conveying embedded and integral business rules, is referred to generally by the reference numeral 100. The system 100 is preferably constructed within a distributed computer network (not shown) via communication channels, whether wired or wireless, as is well known to those of ordinary skill in the pertinent art. In a preferred embodiment, the distributed computer network is the Internet. It is envisioned that the system 100 includes a plurality of clients and servers (not shown).

The system 100 allows for management, distribution and usage of digital works based on the principles of accountability, flexibility and robust protection. The system 100 is an end-to-end system where digital works pass from an Encoding/Encryption Appliance 110 to a Distribution Appliance 120 to a Consumption Appliance 130. The Encoding/Encryption Appliance 110 receives a digital work or unprotected content and creates protected content therefrom. The Distribution Appliance 120 defines grants (as described hereinbelow) that govern the usage of the protected content. The Consumption Appliance 130 exercises the grants to transform the protected content into exercisable content and, thereby, bound the consumption process by the rules defined by the grants.

It is envisioned that the Encoding/Encryption Appliance 110, the Distribution Appliance 120 and Consumption Appliance 130 can be any now known or later developed device for distributing and/or using digital and analog works. For example, any of a number of servers known to those skilled in the art that are intended to be operably connected within the system 100 so as to operably link to a plurality of clients. A typical server includes a central processing unit including one or more microprocessors such as those manufactured by Intel or AMD, random access memory (RAM), mechanisms and structures for performing I/O operations, a storage medium such as a magnetic hard disk drive(s), and an operating system for execution on the central processing unit. The hard disk drive of the server may be used for storing data, client applications and the like utilized by client applications. The hard disk drive(s) of the server also are typically provided for purposes of booting and storing the operating system, other applications or systems that are to be executed on the server, paging and swapping between the hard disk and the RAM.

Clients may be, without limitation, desktop computers, laptop computers, personal digital assistants, and cellular telephones operating on analog or digital signals and works. The clients allow users to access information on the server. The clients have displays and an input device(s) as would be appreciated by those of ordinary skill in the pertinent art. The display may be any of a number of devices known to those skilled in the art for displaying images responsive to outputs signals. Such devices include but are not limited to cathode ray tubes (CRT), liquid crystal displays (LCDS), plasma screens and the like. Although certain computers are described, it is appreciated by those of ordinary skill in the art that the subject technology shall not be construed as limited to the described embodiments.

Still referring to FIG. 1, the system 100 originates with unprotected content or a digital work presented into an Encoding/Encryption Appliance 110, where “Encoding” preferably refers to interweave mode, where encryption is interwoven or encoded directly into the format of the content, and where “Encryption” preferably refers to encapsulation mode or wrapping of content within an encrypted header. The digital work may be such things as audio data (e.g., a song), multimedia (e.g., a movie), a literary work (e.g., a published article) and the like.

The Encoding/Encryption Appliance 110 encrypts the digital work with an encryption algorithm before the digital work is distributed, consumed or otherwise used. The digital work is said to be unencrypted prior to undergoing this encryption algorithm, and is said to be encrypted after undergoing the encryption algorithm. An encryption algorithm transforms the unencrypted digital work into an encrypted digital work through a mathematical function (the “encryption function”) that takes both the unencrypted digital work and an encryption key parameter as inputs, and outputs the encrypted digital work. The encrypted digital work can only be transformed back to its unencrypted form through a corresponding mathematical function (the “decryption function”) that receives the same encryption key parameter as input, as well as the encrypted digital work as an input, and outputs the original unencrypted digital work.

In one embodiment, the Encoding/Encryption Appliance 110 applies an encapsulation-based (wrapping mode) encryption algorithm to a given digital work where the encryption algorithm is applied to the unencrypted digital work in part or in whole, effectively wrapping the content with an encryption layer. Another preferred embodiment applies an interweave encryption mode (encoding mode) to a given digital work in part or in whole, according to the structural format of the unencrypted digital work, therein retaining the basic structural format of the unencrypted digital work while yet sufficiently modifying the digital work to prevent meaningful evaluation or usage of the digital work.

In another preferred embodiment, the Encoding/Encryption Appliance 110 utilizes block cipher cryptographic systems incorporating an encryption function for fixed-size blocks, encrypting specific-size plaintext and generating specific-size ciphertext as the result. Block ciphers are reversible in that there exists a decryption function that a given size ciphertext to the original plaintext.

Generally, the optimal choice of an encryption algorithm is dependent on the structural format of the digital work, the medium in which digital work is transported or otherwise distributed, and the capabilities of the system 100 that process encryption functions and/or decryption functions, therein transforming the digital work. These characteristics include but are not limited to processor speed, memory capacity, memory access speed, and sub-component/component/subsystem/system static/dynamic queuing and queuing system utilization characteristics. Block cipher algorithms and keys employed in a preferred embodiment include Advanced Encryption Standard (AES), Serpent, Rivest Cipher 6 (RC6), MARS, Twofish, Data Encryption Standard (DES), and Triple-DES (3DES) block cipher algorithms. Encryption algorithms may differ from one another in factors that include processing speed of the encryption function, processing speed of the decryption function, allowed, required sizes for the encryption key input parameter(s), strength of security, or size differentials between unencrypted and encrypted digital work.

A preferred embodiment utilizes AES to provide encryption and key functions. AES, unlike DES, is not a Feistel cipher. AES initial and subsequent rounds (repetitions of the block cipher) are similar, where an AES round initializes with plaintext presented as 16 bytes at the top, the initial operation is to Exclusive OR (XOR, that is, bitwise addition or addition without carry) the plaintext with 16 bytes (128 bits) of round key, each of the 16 bytes (128 bits) is subsequently used as an index into an S-box table that maps 8-bit inputs to 8-bit outputs. Preferably, the S-boxes are all identical and the bytes are subsequently rearranged into a specific order, following which the bytes are mixed in groups of four through use of a linear mixing function. A full AES encryption consists of ten to fourteen rounds as a function of key size, with a key schedule that generates necessary round keys.

Another preferred embodiment utilizes Serpent to provide encryption and key functions. Serpent has a structure similar to AES in that it consists of 32 rounds, each round in turn consisting of XORing in a 128-bit round key, applying a linear mixing function to the 128 bits, then applying 32 4-bit S-boxes in parallel. Each round of 32 S-boxes are identical, with eight different S-boxes used each in sequence within a given round. Serpent is generally the preferred encryption embodiment for the disclosed invention when encryption/decryption security is required over processing speed, and where processing speed of approximately one-third that of AES is acceptable. Serpent processing speed is less efficient than that of AES primarily as a function of the requirement to convert the S-boxes to a Boolean formula suitable to the underlying Central Processing Unit (CPU).

Another preferred embodiment utilizes RC6 to provide encryption and key functions, incorporating 32-bit multiplications in the cipher. Still another preferred embodiment utilizes MARS to provide encryption and key functions. MARS is a 128-bit block cipher with key length, Type-3 Feistel network that can vary from 128 to greater than 400 bits, generally in increments of 128-, 192-, or 256-bits. The MARS cryptographic core utilizes 16 rounds to encrypt and decrypt digital work, with the inner core wrapped by a layer of mixing rounds that do not encrypt/decrypt, but prepare input to the cryptographic core. A different preferred embodiment utilizes Twofish to provide encryption and key functions. Twofish is functionally a compromise between AES and Serpent, utilizes the same Feistel structure as DES, and splits 128-bit plaintext into four 32-bit values, with the majority of operations on 32-bit values. The Twofish mixing function is similar to the AES mixing function, with distinct S-boxes to the extent that the S-boxes are not constant but rather their content depends on the key. That is, a Twofish algorithm computes the S-box tables from key material.

A preferred embodiment utilizes DES to provide encryption and key functions, with 56-bit key and 64-bit blocksize, 64-bit plaintext split into two 32-bit halves, accomplished by rearranging the bits in a semi-ordered fashion. DES consists of 16 rounds and is structured as a Feistel requiring 16 round keys of 48 bits each. A preferred embodiment utilizes 3DES to provide encryption and key functions. 3DES has a 64-bit blocksize and is a block cipher constructed from three DES encryptions in sequence.

Another preferred embodiment utilizes and integrates any combination of the block ciphers described herein. Preferably, another embodiment utilizes and integrates a plurality of any combination of block cipher-based and non-block cipher-based encryption algorithms and keys. A preferred embodiment generates a list of small primes whereby any composite number p is divisible by a prime that is smaller than p, all candidate numbers are initialized as potential primes by setting an initialization flag, the initial selected prime is 2, candidate prime numbers are incremented until subsequent prime candidates are selected that are not divisible by any smaller prime, and until the pre-determined limit of candidate primes, n, is less than the square of identified primes, where identified small primes are incorporated into any combination of block cipher-based and non-block cipher-based encryption algorithms and keys.

In another embodiment, the system 100 generates a list of large primes through use of a multi-precision library, utilizing the natural logarithm of n (logn) or a variation thereof, is employed to seek one in every n numbers as prime, where identified large primes are incorporated into any combination of block cipher-based and non-block cipher-based encryption algorithms and keys. A preferred embodiment also generates large primes of the forms (p#+1) and (p#−1) utilizing multi-form combinations of the Chinese Remainder Theorem. A preferred embodiment generates large primes of the forms (p#+1) and (p#−1) utilizing multi-form combinations of the valence of Euler's Function.

Still another embodiment generates large primes of the forms (p#+1) and (p#−1) utilizing multi-form combinations of Primality Tests based on Lucas Sequences. A preferred embodiment of the disclosed invention generates large primes of the forms (p#+1) and (p#−1) utilizing multi-form combinations of Fermat Numbers. A preferred embodiment generates large primes of the forms (p#+1) and (p#−1) utilizing multi-form combinations of Mersenne Numbers. A preferred embodiment generates large primes of the forms (p#+1) and (p#−1) utilizing multi-form combinations of any combination or permutation of the Chinese Number Theorem, the valence of Euler's Function, Primality Tests based on Lucas Sequences, Fermat Numbers, or Mersenne Numbers. A preferred embodiment generates pseudoprimes in Base 2 (psp). A preferred embodiment generates pseudoprimes in Base a [psp(a)], a-pseudoprimes, which are the composite integers n>a such that aⁿ⁻¹ is always=1 (mod n). A preferred embodiment generates Euler pseudoprimes in Base a [epsp(a)], and odd composite numbers n, such that gcd(a,n)=1 and the Jacobi symbol satisfies the congruence (a/n) always=a^{(n-1)/2} (mod n)). A preferred embodiment generates Lucas pseudoprimes. A preferred embodiment generates strong Lucas pseudoprimes, Euler-Lucas pseudoprimes, Fibonacci pseudoprimes, or Carmichael-Lucas numbers.

Another preferred embodiment conducts a range of general-purpose and special-purpose primality testing sequences based on variations of Riemannn's Zeta Function, to the extent that Euler's Theorem indicates that the sum of the reciprocals of the prime numbers is a divergent series, and recognizes that the prime reciprocal sequence diverges in a logarithmic fashion.

In still another embodiment, the system 100 utilizes the orthogonality property of sines and cosines, based on Fourier analysis, to perform on-the-fly extraction, on-the-fly analysis, and on-the-fly signal re-processing of specific frequencies and amplitudes of signals present in the digital works, where 1 through n sine-cosine pairs, each a multiple of a fundamental frequency, are multiplied together, followed by first-, second-, and third-order integration of the product over 1 to n periods of specific, identified signal frequencies digitally represented within the digital works, with the result equal to zero except in specific cases, resulting in rapid predictive encoding, decoding, and distribution of digital works including but not limited to, generalized digital content, entertainment digital content, advertising digital content, video-specific digital content, audio-specific digital content, software distribution-specific digital content, graphic-specific digital content, mixed-object digital content and analog versions of the similar.

A preferred embodiment performs post-multiplication integration of 1 to n sine-cosine pairs based on the possible presence of non-periodic functions, where the period tends to infinity, and consequently the digitally-encoded fundamental frequency tends to zero. In this case, the harmonics are increasingly-closely spaced leading to a continuum of harmonics in the limit, each one of infinitesimal amplitude and therefore, the utilization of post-multiplication first-, second-, and third-order integration in the present invention. Post-integration analysis in the present invention is based to some extent on applying a top-hat function to phase transforms output from the Fourier transform.

A preferred embodiment generates digital harmonic amplitude-specific tags (meta-tags) for encrypted/encoded content. Another preferred embodiment performs Fourier transform analyses in one-, two-, three-, and four dimensions (multi-dimensional Fourier transforms), based to some extent on multi-dimensional Fourier transform-based computer axial tomography as applied to digital works. A preferred embodiment associates twin primes of the general form (p, p+2) to multi-dimensional Fourier transform analyses on 1 through n sine-cosine pairs of digitally-encoded Digital Works.

In another embodiment, the system 100 introduces an abstract encryption layer that can support any encryption algorithm (block cipher or otherwise), enabling any encryption algorithm to be integrated into the system 100 of the preferred embodiment as a whole. A preferred embodiment specifically enables generation and storage of any sizes of encryption key input parameters that are allowed and/or required for any given encryption algorithm.

Distribution Appliance

Still referring to FIG. 1, the output of the Encoding/Encryption Appliance 110 is protected content which is presented as input to a Distribution Appliance 120. The Distribution Appliance 120 adds rules to the protected content which govern the usage of protected content, including rules governing consumption and subsequent distribution, and participates in delivery of protected content to a Consumption Appliance 130. The protected content can pass through a series of one or more Distribution Appliances 120, systematically acquiring rules through each Distribution Appliance 120.

The output of the Distribution Appliance 120 is protected content with business rules. To this extent, the Distribution Appliance 120 incorporates encrypted, n-generational embedded business rules into the content. Protected content with embedded rules can be passed as input to another Distribution Appliance 120, where additional rules can be applied, or the protected content can be passed to a Consumption Appliance 130, which enables an end user to consume the content from its “protected with rules” form, therein ensuring that the consumption process is bounded by the rules expressed for the content.

Distribution Graph

The distribution of protected content through one or more Distribution Appliances 120 to one or more end-system Consumption Appliances 130 creates a distribution graph. A distribution graph is a directed acyclic graph consisting of vertices and edges, where a vertex represents a Distribution Appliance 120 or a Consumption Appliance 130, and an edge represents the distribution of protected content between a Distribution Appliance 120 and a Consumption Appliance 130 or other Distribution Appliance 120. The typical distribution graph begins with a single Distribution Appliance 120 and ends with one or more Consumption Appliances 130, and indicates candidate distribution paths of protected content from a specific Encoding/Encryption Appliance 110 to specific Consumption Appliances 130.

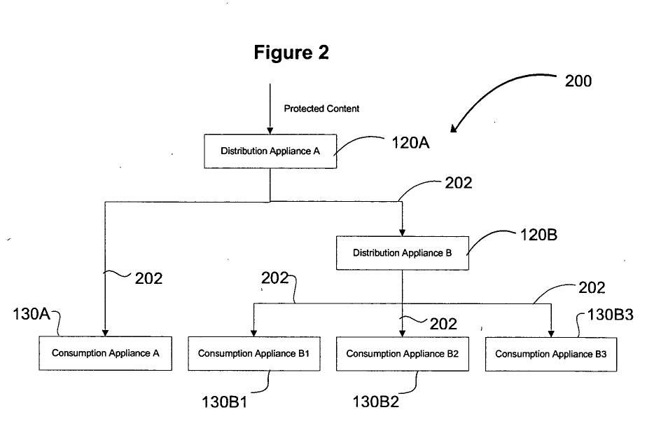

Referring now to FIG. 2, an exemplary distribution graph is referred to generally by the reference numeral 200. It is envisioned that a plurality of Encoding/Encryption appliances 110, Distribution Appliances 120 and Consumption Appliances 130 may exist in an infinite number of configurations. In distribution graph 200, Distribution Appliance 120A adds rules to the protected content received from an Encoding/Encryption Appliance 110. Consumption Appliance 130A directly receives protected content with rules from Distribution Appliance 120A.

The Distribution Appliance 120B also receives protected content with rules from Distribution Appliance 120A and adds additional rules associated with Distribution Appliance 120B. Consumption Appliances 130B1, 130B2 and 130B3 receive protected content from Distribution Appliance 120B, where the protected content contains rules embedded from both Distribution Appliances 120A and 120B. Accordingly, each Distribution Appliance 120 and Consumption Appliance 130 is a vertex in the distribution graph 200. Further, the communication of protected content from each Distribution Appliance 120 is an edge 202.

Distribution Ruleset

A distribution ruleset is created by a Distribution Appliance 120, and is cumulative as protected content is distributed through subsequent Distribution Appliances 120. Distribution rulesets specify the rules, which govern or restrict certain permutations of a distribution graph, including permitted and restricted acts of distribution and consumption. It is envisioned that a distribution ruleset is a directed, acyclic graph, defining the allowed permutations of the distribution graph that may occur after the Distribution Appliance 120 specifies the distribution ruleset.

Referring still to FIG. 2, Distribution Appliance 120A defines a distribution ruleset, and Distribution Appliance 120B creates an additional distribution ruleset. It is noteworthy that the distribution ruleset from Distribution Appliance 120A still applies after leaving Distribution Appliance 120B, however, the distribution ruleset input to Distribution Appliance 120B further restricts the definition of the Distribution Appliance 120B-generated distribution ruleset, thereby providing the foundation for an intelligent, n-generational distribution ruleset function.

Vertices of a distribution ruleset (hereinafter also referred to as an appliance set) indicate categories of Distribution Appliances 120 and/or Consumption Appliances 130 permitted to distribute/consume the protected content after the specifying Distribution Appliance 120. Edges of a distribution ruleset or distribution edges indicate permitted paths that protected content may be distributed through to one or more appliance sets after the specifying Distribution Appliance 120.

A distribution ruleset or distribution rules graph begins with an appliance set that contains only the specifying Distribution Appliance 120. A distribution rules graph completes with one or more appliance sets, configured such that the resulting permutations of distribution graphs completes with one or more consumption appliances 120. An appliance set may have zero, one, or more output distribution edges (e.g., the characteristic of a directed acyclic graph having zero, one or more output edges for each vertex).

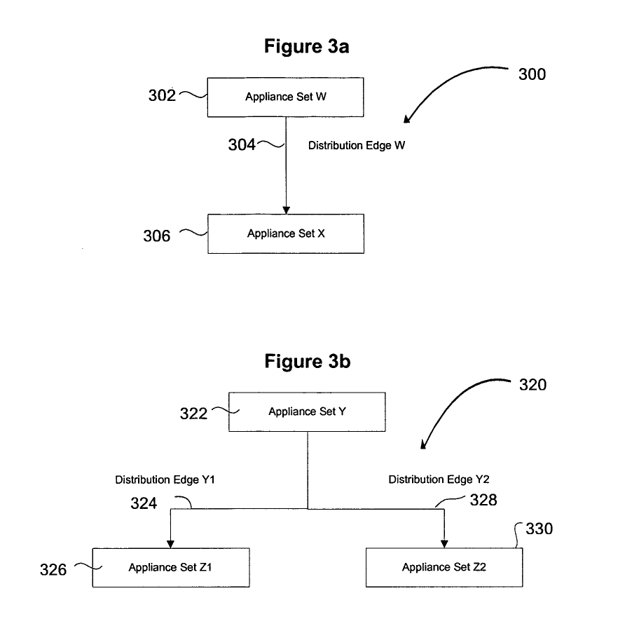

Referring to FIGS. 3a and 3b, a minimal distribution graph-based distribution ruleset 300 and a refined distribution graph-based distribution ruleset 320 are shown, respectively. The minimal distribution ruleset 300 controls permutations of a distribution graph. In the context of the Distribution Appliance 120A depicted in FIG. 2, this Distribution Appliance 120A functions as the specifying Distribution Appliance in FIG. 3a. Appliance Set W 302 is defined as containing the specifying Distribution Appliance 120A. Distribution Edge W 304 defines the allowed distribution path of protected content to an Appliance Set X 306. Appliance Set X 306 ultimately resolves to specific instances of Consumption Appliances 130 in a distribution graph, which may also contain Distribution Appliances 120 as shown, for example in FIG. 2.

Referring now to FIG. 3b, the refined distribution graph-based distribution ruleset 320 is shown for the Distribution Appliance 120B as introduced in FIG. 2. In this regard, the Distribution Appliance 120B is operating in the role of the specifying Distribution Appliance. Appliance Set Y 322 is defined as containing the specifying Distribution Appliance 120B. Distribution edge Y1 324 defines the allowed distribution path of protected content to an appliance set Z1 326. Distribution edge Y2 328 defines the allowed distribution path of protected content to an appliance set Z2 330. Appliance set Z1 326 resolves to Consumption Appliances 130B1 and 130B2. Appliance set Z2 330 resolves to Consumption Appliance 130B3.

Distribution Edge

Still referring to FIG. 3b, distribution edges 324, 328 indicate paths to appliance sets through which protected content may be distributed, as output from the respective specifying Distribution Appliance. A Distribution Edge can be configured in a plurality of ways, and controls the distribution of protected content from the specifying Distribution Appliance. Each of these configuration aspects may be configured by an operator of the specifying Distribution Appliance to control the distribution of protected content. In a preferred embodiment, configuration aspects include edge conditions, grants, demands, subdivision restrictions, grant restrictions and demand restrictions.

Edge Conditions

An edge condition represents the qualifying condition or conditions that permit a specific Distribution Appliance 120 or Consumption Appliance 130 to belong in a distribution edge's target appliance set. That is, an edge condition specifies the conditions under which the distribution edge is used as a distribution path for the protected content. An edge condition is identified by evaluating the attributes or appliance attributes of a Distribution Appliance 120 or Consumption Appliance 130, the current state of the distribution graph (i.e., the Distribution State), or any information associated with the protected content (such as content metadata), and comparing the evaluated attributes with known values or other appliance attributes, distribution state or content metadata.

In a preferred embodiment, appliance attributes include whether an appliance is a Distribution Appliance 120 or Consumption Appliance 130, the identity of the Distribution Appliance 120 and/or Consumption Appliance 130 and the identity of the end-system operating the Distribution Appliance 120 and/or Consumption Appliance 130 during evaluation of the edge system. Examples of distribution state data include date and time at the appliance at which the edge condition is evaluated, the identity of the Distribution Appliances 120 that have already participated in the distribution of the protected content and a number of Distribution Appliances 120 that have already participated in the distribution of the protected content. Examples of Content Metadata include author(s) of the protected content, title(s) of the protected content, and duration of the protected content (e.g., for audio or video content). Examples of Comparisons include equivalence, numerical comparisons such as greater than, less than, text pattern matching through regular expressions. logical combinations of any of the above types of comparisons (such as AND, OR, XOR logic) and negation of any combination of the above types of comparisons (such as NOT logic).

Grants

A grant is the permission to perform a certain action on the protected content, and is associated with a distribution edge to indicate that such an action on the protected content is permitted if and only if the protected content is distributed along the distribution edge. The edge condition that is used to effectively define when the distribution edge is used to distribute protected content thus qualifies when the action is permitted. Examples of grants include viewing the protected content (e.g., a document), playing the protected content (e.g., an audio or video content), printing the protected content, copying the protected content and distributing the protected content to others.

Demands

A demand indicates that a certain reciprocal action must be performed before a granted action is exercised on the protected content, and is associated with a granted action (and indirectly, the distribution edge) to indicate that the demand on the protected content is requested if and only if the protected content is distributed along the distribution edge, and the granted action is exercised on the protected content. The edge condition that is used to effectively define the distribution edge thus qualifies when the demand is in effect. A demand may have one or more parameters that quantify the reciprocal action that is expected. Examples of demands include a fee that is required to perform a granted action (a parameter of the fee demand may be the monetary amount of the fee), and a requirement that an electronic survey form be answered before the granted action is exercised (parameters of the survey demand may be the questions asked in the survey).

Subdivision Restrictions

A subdivision restriction refers to the ability of subsequent Distribution Appliances 120 to create distribution rulesets that effectively subdivide the associated source distribution edge into multiple derived distribution edges, each of which introduce a new appliance set. Subdivision of a source distribution edge into derived distribution edges requires that the derived distribution edges respect all other aspects of the source distribution edge (e.g., grants, demands, edge condition). A subdivision restriction can specify that subdivision is not allowed, exclusive or inclusive. An exclusive subdivision indicates that subdivision may occur such that the union of appliances in the appliance sets defined by each derived distribution edge is a subset of the appliances in the appliance set defined by the source distribution edge.

An inclusive subdivision indicates that subdivision may occur if and only if the union of appliances in the appliance sets defined by each derived distribution edge exactly matches the set of appliances in the appliance Set defined by the source distribution edge. For example, Distribution Appliance 120B (see FIG. 2) has subdivided (either inclusively or exclusively) distribution edge W 304 (see FIG. 3a) into distribution edge Y1 324 and distribution edge Y2 328 (see FIG. 3b) in its specification of a Distribution Ruleset.

Grant Restrictions

A grant restriction refers to the ability of subsequent Distribution Appliances 130 to create distribution rulesets that specify grants in addition to the grants already specified by the specifying Distribution Appliance 130 and any prior Distribution Appliances 130. A grant is associated with a distribution edge to indicate that a further grant may be issued on the distribution edge or on a derived distribution edge if the distribution edge has been subdivided.

Demand Restrictions

A demand restriction refers to the ability of subsequent Distribution Appliances 130 to create distribution rulesets that specify demands in addition to the demands already specified by the specifying Distribution Appliance 130 and any prior Distribution Appliances 130. A demand restriction is associated with a grant or grant restriction (and thus indirectly a distribution edge) to indicate that a further demand may be issued on the distribution edge or on a derived distribution edge if the distribution edge has been subdivided. A demand restriction may also indicate allowed or required values for the demand's parameter(s). The allowed or required values may be specified through the same comparison mechanism used to identify an edge condition [e.g., equivalence, AND, or OR logice].

Licensing Appliance

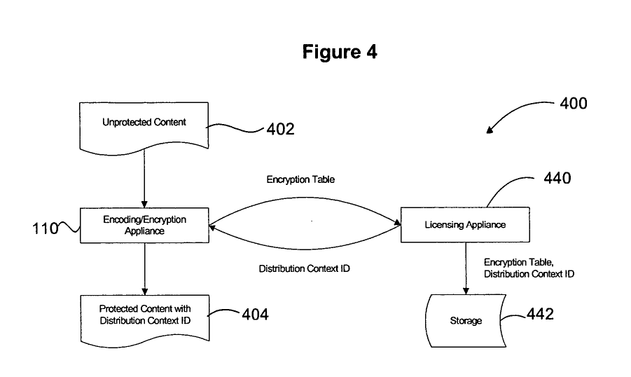

Referring now to FIGS. 4, 5 and 6, another system 400 having a Licensing Appliance 440 is shown. The Licensing Appliance 440 is involved in the encoding/encryption, distribution and consumption of content, specifically through interactions with Encoding/Encryption Appliances 110, Distribution Appliances 120 and Consumption Appliances 130.

Licensing Appliance Interaction with Encoding/Encryption Appliance

Referring in particular to FIG. 4, unprotected content 402 is an input to the Encoding/Encryption Appliance 110. The Licensing Appliance 440 is involved when unprotected content is encrypted into protected content by an Encoding/Encryption Appliance 110. The unprotected content 402 is passed as an input to the Encoding/Encryption Appliance 110. The Encoding/Encryption Appliance 110 uses an encryption algorithm or plurality of encryption algorithms using one or more input encryption key parameters to encrypt the unprotected content into protected content form, and applies a plurality of encryption algorithms and input encryption key parameters in an encapsulation and interweaving encryption mode. The particular information is combined to form an encoding table. The encoding table is used to identify encryption algorithms used and the portions of the content that were encrypted using a plurality of possible encryption algorithms, identify input encryption key parameters and the portions of the content that were encrypted with each input encryption key, identify the encryption mode used, that is, whether encapsulation or interweaving mode was used, assign a unique identifier for the protected content, such as use of MD5 hash of the unprotected content and assign a unique identifier for the Encoding/Encryption Appliance 110 (e.g., digital certificate or other means of uniquely identifying the appliance).

In an Internet embodiment, the encoding table is communicated to the Licensing Appliance 440 through a secure network communications protocol request such as through Hypertext Transfer Protocol (HTTP) over Secure Sockets Layer (SSL). The Licensing Appliance 440 generates a Distribution Context ID that uniquely identifies the encoding table (e.g., a statistically random value). The Licensing Appliance 440 stores the encoding table as a record into a secure storage mechanism 442, associating the encoding table with the Distribution Context ID, such as a Relational Database Management System (RDBMS)

The Licensing Appliance 440 returns a Distribution Context ID to the Encoding/Encryption Appliance 110 via a secure network communications protocol response. As a result, the output of the Encoding/Encryption Appliance 110 is the protected content with the Distribution Context ID 404. The Distribution Context ID effectively identifies the rules that are attached to the protected content at any given time, following which the Distribution Context ID indicates that no rules/rulesets are attached.

Licensing Appliance Interaction with Distribution Appliance

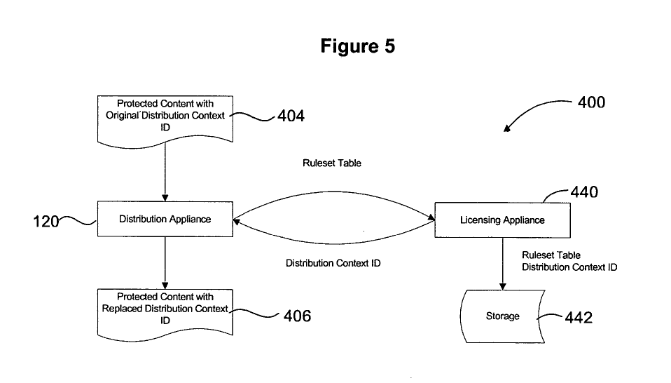

Referring in particular to FIG. 5, when specifying a distribution ruleset, a Distribution Appliance 120 registers the distribution ruleset with the Licensing Appliance 440. The protected content with an “original” Distribution Context ID 404 passes as an input parameter to the Distribution Appliance 120. The protected content 404 may originate from another Distribution Appliance 120 or an Encoding/Encryption Appliance 110, and may have been transferred over a network.

The Distribution Appliance 120 prepares a ruleset table that identifies the distribution ruleset that will be added to the protected content. The ruleset table contains a representation of the configuration aspects used to configure the distribution ruleset (e.g., the edge conditions, grants, demands, subdivision restrictions, grant restrictions and demand restrictions). Preferably, the Distribution Appliance 120 may also encrypt the protected content 440. As in the case of the Encoding/Encryption Appliance 110, the Distribution Appliance 120 may use an encryption algorithm or plurality of encryption algorithms using one or more input encryption key parameters to further encrypt the protected content (or portions of the protected content), and may apply a plurality of encryption algorithms and input encryption key parameters in an encapsulation or interweaving encryption mode. The Distribution Appliance 120 may repeat the encryption multiple times (with each iteration involving different encryption algorithms, keys and encryption mode) to associate an encryption iteration with one or more grants that have been specified in the Distribution Ruleset.

Each encryption iteration results in a re-encoding table. In a preferred emdbodiment, the re-encoding table includes identification of encryption algorithms used and the portions of the content that were encrypted with each encryption algorithm, identification of input encryption key parameters and the portions of the content that were encrypted with each input encryption key and the encryption mode, i.e. whether encapsulation or interweaving mode was used. The Distribution Appliance 120 completes the Ruleset Table by combining the following information: the configuration aspects of the Distribution Ruleset; one or more re-encoding tables that represent each encryption iteration; a mapping identifying the associations between re-encoding tables and grants issued in the distribution ruleset; a unique identifier for the Distribution Appliance 120 (e.g., digital certificate or other means of uniquely identifying the appliance); and the original distribution context ID specified along with the input protected content. The resulting ruleset table is communicated to the Licensing Appliance 440 through a secure network communications protocol request.

The Licensing Appliance 440 ensures that the distribution ruleset configuration aspects specified in the ruleset table are permitted by the configuration aspects of any distribution rulesets previously recorded for other Distribution Appliances 120. The inclusion of the original distribution context ID in the ruleset table enables backward navigation of these distribution rulesets. This navigational ability enables the discovery of the protected content's distribution graph.

By having the ruleset table, the Licensing Appliance 440 generates a distribution context ID that uniquely identifies the ruleset table (e.g., a statistically random value). The Licensing Appliance 440 stores the ruleset table as a record into a secure storage mechanism 442, associating the ruleset table with the distribution context ID. The Licensing Appliance 440 returns the distribution context ID to the Distribution Appliance 120 via a secure network communications protocol response. The output of the Distribution Appliance 120 is the protected content and the distribution context ID 406. The distribution context ID effectively identifies the rules (or specifically, the Ruleset Table) associated with the modified protected content output by the Distribution Appliance 120.

Licensing Appliance Interaction with Consumption Appliance

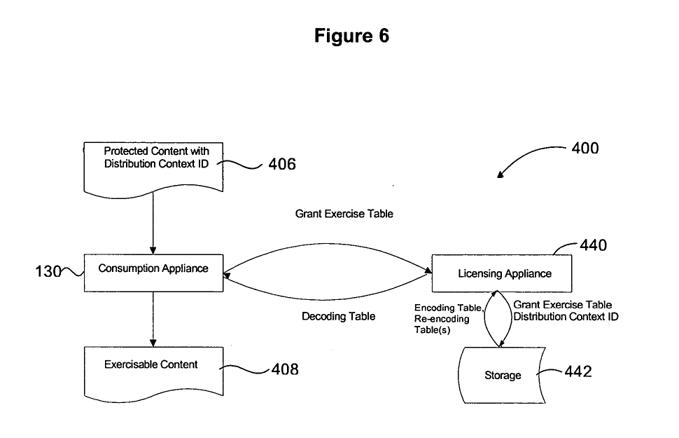

Referring in particular to FIG. 6, the Consumption Appliance 120 exercises one or more grants (as defined by Distribution Appliances 120) to transform protected content 406 into an exercisable form or exercisable content 408. In order to exercise a grant, typically the Consumption Appliance 130 must retrieve encryption information stored at the Licensing Appliance 440 that has been registered by Encoding/Encryption Appliances 110 and Distribution Appliances 120. The Consumption Appliance 130 uses this encryption information to decrypt the protected content 406 (or portions of the protected content), transforming the protected content to the exercisable content form where the grant can be exercised.

The input of the Consumption Appliance 130 is the protected content 406 that has been output from a Distribution Appliance 120. The protected content 406 may have been transferred over a network. In a preferred embodiment, the Consumption Appliance 130 prepares a grant exercise table that contains the following information: the distribution context ID of the protected content; a unique identifier for the Consumption Appliance 130 (e.g., digital certificate or other means of uniquely identifying the appliance); and a list of grants that the Consumption Appliance 130 is requesting to exercise.

This grant exercise table is communicated to the Licensing Appliance 440 through a secure network communications protocol request. The Licensing Appliance 440 ensures that the grants the Consumption Appliance 130 is requesting are permitted by the distribution rulesets specified by any Distribution Appliances 120 involved in distributing the protected content 406. The graph of distribution rulesets can be determined by recursive backward navigation of the distribution context ID against ruleset tables defined by the Distribution Appliances 120.

The Licensing Appliance 440 stores the grant exercise table as a record into a secure storage mechanism 442, associating the grant exercise table with the distribution context ID. The storage of the grant exercise table enables auditing of the exercised grant(s). Using recursive backward navigation of the distribution context ID against the ruleset tables defined by Distribution Appliances 120 (as stored in the storage mechanism 442), any encoding table or re-encoding table that contains encryption information required to exercise the grant(s) is determined by the Licensing Appliance 440. A preferred embodiment is to perform recursive backward navigation as procedural instructions executing within the host central processing unit of the Licensing Appliance 440. Another preferred embodiment is to perform the recursive backward navigation by storing ruleset tables in a relational database management system (not shown) using adjacency list or nested set data structures, and then performing structured query language (SQL) queries upon those structures.

Based upon the analysis of the grant exercise table, the Licensing Appliance 440 generates a decoding table to present an ordered list of re-encoding table(s) and/or encoding table as required to decrypt the protected content 406. The re-encoding table(s) and/or encoding table are in reverse order to the order in which each were registered by the Licensing Appliance 440 in response to requests from the Encoding/Encryption Appliances 110 and the Distribution Appliances 120.

The Licensing Appliance 440 returns the decoding table to the Consumption Appliance 130 via a secure network communications protocol response. The Consumption Appliance 130 uses the encryption information recorded in the decoding table to perform multiple iterations of decryption to transform the protected content into exercisable content 408. Each decryption iteration uses the identified encryption algorithm(s) (and indication of the portions of the protected content where the algorithm(s) were applied), identified input encryption key parameter(s) (and indication of the portions of the protected content where the input encryption key parameter(s) were applied), and identified encryption mode to perform the decryption. The resulting output of the Consumption Appliance 130 is the exercisable content form of the protected content 406. As a result, the grant(s) defined on the protected content can now be performed.

In one embodiment, an instruction set for the systems 100, 400 is a desktop computer application that is either downloaded or provided on a compact disk. In another embodiment, the instruction set is offered as an Internet hosted application. Each user is allowed to customize the various options according to individual applications.

It will be appreciated by those of ordinary skill in the pertinent art that the functions of several elements may, in alternative embodiments, be carried out by fewer, or a single element. Similarly, in some embodiments, any functional element may perform fewer, or different, operations than those described with respect to the illustrated embodiment. Also, functional elements (e.g., appliances, modules, databases, interfaces, computers, servers and the like) shown as distinct for purposes of illustration may be incorporated within other functional elements in a particular implementation. For example without limitation, an appliance may be a desktop computer, laptop computer, personal digital assistant, a cellular telephone, a server, a network of servers and the like and the licensing appliance may be incorporated in the same element as the distribution appliance and so on.

While the invention has been described with respect to preferred embodiments, those skilled in the art will readily appreciate that various changes and/or modifications can be made to the invention without departing from the spirit or scope of the invention as defined by the appended claims.

What is claimed is:

1. A system for managing, distributing and using of electronic content comprising:
an encoding/encryption appliance for receiving content and creating protected content;
a distribution appliance for defining one or more grants; and
a consumption appliance for exercising the one or more grants to transform the protected content into exercisable content.

2. A system as in claim 1, wherein creating the protected content includes encoding directly into a format of the content, and wrapping of data within an encrypted header associated with the protected content.

3. A system as in claim 1, wherein the encoding/encryption appliance is further operative to attach a distribution context identifier to the protected content for identifying rules that are attached to the protected content.

4. A system as in claim 3, wherein the distribution appliance is further operative to modify the protected content such that a ruleset table associated with the rules is identified.

5. A system as in claim 4, wherein the distribution appliance is further operative to add additional rules to the protected content, the rules governing usage of the protected content.

6. A system as in claim 5, wherein the additional rules restrict a definition of the ruleset table.

7. A system as in claim 4, further comprising a licensing appliance for ensuring that the grants requested by the consumption appliance are permitted by the ruleset table specified by the distribution appliance.

8. A system as in claim 7, wherein the encoding/encryption appliance is further operative to create an encoding table consisting of:
an encryption algorithm used and portions of the protected content that were encrypted using the encryption algorithm;
input encryption key parameters;
portions of the protected content that were encrypted with each input encryption key parameters;
a flag indicating whether encapsulation or interweaving mode was used;
a unique identifier for the protected content; and
a unique identifier for the encoding/encryption appliance.

9. A system as in claim 8, wherein the encoding table is communicated to the licensing appliance through a secure network communications protocol request and associated with the protected content.

10. A system as in claim 5, wherein the additional rules define one or more distribution edges, the distribution edges being selected from the group consisting of edge conditions, grants, demands, subdivision restrictions, grant restrictions, and demand restrictions.

11. A system as in claim 1, wherein the consumption appliance is further operative to prepare a grant exercise table consisting of a distribution context identifier associated with the protected content, a unique identifier for the Consumption Appliance, and a list of grants that the consumption appliance requests to exercise.

12. A system as in claim 1, wherein the content is selected from the group consisting of generalized digital content, entertainment digital content, advertising digital content, video-specific digital content, audio-specific digital content, software distribution-specific digital content, graphic-specific digital content, and mixed-object digital content.

13. A server for facilitating distributing electronic works, wherein the server communicates with servers and clients via a distributed computing network, and wherein the server comprises:
(a) a memory storing an instruction set and data related to a plurality of consumption appliances, a plurality of encoding/encryption appliances and distribution edges associated with an electronic work; and
(b) a processor for running the instruction set, the processor being in communication with the memory and the distributed computing network, wherein the processor is operative to:
(i) receive protected content from an encryption/encoding appliance;
(ii) add rules to the protected content that govern consumption and distribution of the protected content; and
(iii) send the protected content with the rules to a consumption appliance such that the consumption appliance can render the protected content into an exercisable form if such usage is permitted.

14. A server as recited in claim 13, wherein the processor is further operative to pass the protected content with the rules to a second sever where additional rules are applied to the protected content.

15. A server as recited in claim 13, wherein the processor is further operative to pass a ruleset table associated with the rules to a licensing appliance.

16. A computer-readable medium whose contents cause a server to perform a method for facilitating distribution and consumption of content in a distributed computing environment, the distributed computing environment having a plurality of encoding appliances, consumption appliances and distribution appliances, the server having a digital signal processor and a program with functions for invocation by performing the steps of:
a) receiving an encryption table associated with a work from an encoding appliance;
b) creating a first identifier for the work, the first identifier being associated with the encryption table;
c) sending the first identifier to the encoding appliance;
d) receiving a ruleset table associated with the work from a distribution appliance;
e) creating a second identifier for the work, the second identifier being associated with the ruleset table;
f) sending the second identifier to the distribution appliance;
g) receiving a grant exercise table associated with the work from a consumption appliance;
h) creating a decoding table for the work based upon the grant exercise table, the ruleset table and the encryption table; and
i) sending the decoding table to the consumption appliance.

17. A computer-readable medium as recited in claim 16, wherein the encryption table includes data selected from the group consisting of encryption algorithms used, portions of the work that were encrypted, input encryption key parameters and portions of the content that were encrypted with each input encryption key, an encryption mode used and combination thereof.

18. A computer-readable medium as recited in claim 17, wherein the ruleset table contains data selected from the group consisting of a representation of configuration aspects used to configure a distribution ruleset such as the edge conditions, grants, demands, subdivision restrictions, grant restrictions and demand restrictions.

19. A computer-readable medium as recited in claim 18, wherein the computer readable medium further includes functions for invocation by performing the step of ensuring that a distribution ruleset configuration aspects specified in the ruleset table are permitted by configuration aspects of any distribution rulesets previously recorded for other distribution.

20. A computer-readable medium as recited in claim 19, wherein the computer readable medium further includes functions for invocation by performing the step of ensuring that grants that the consumption appliance is requesting are permitted by the distribution ruleset.
